(19) United States
(12) Patent Application Publication
(10) Pub. No.: US 2011/0095982 A1
(43) Pub. Date: Apr. 28, 2011

(54) COMPUTER MOUSE

(75) Inventors: KUAN-HONG HSIEH, Tu-Cheng (TW); HAN-CHE WANG, Tu-Cheng (TW); RUEY-SHYANG YOU, Tu-Cheng (TW); XIAO-GUANG LI, Shenzhen City (CN); XIN ZHAO, Shenzhen City (CN); ZU-PEI HE, Shenzhen City (CN)

(73) Assignees: HONG FU JIN PRECISION INDUSTRY(ShenZhen)CO., LTD., Shenzhen City (CN); HON HAI PRECISION INDUSTRY CO., LTD., Tu Cheng (TW)

(21) Appl. No.: 12/878,958

(22) Filed: Sep. 9, 2010

(30) Foreign Application Priority Data
Oct. 28, 2009 (CN) 200910308962.2

(51) Int. Cl. G06F 3/033

(52) U.S. Cl. 345/166

(57) ABSTRACT

A computer mouse includes a housing and two wheels that are capable of rolling on a supporting surface. A first pair of light sources and a second pair of light sources are arranged at one side of the two wheels, respectively. A light sensor changes from a first state to a second state after receiving light, and changes from the second state to the first state after the light is blocked. A driving module is used for successively turning on the first pair of light sources and the second pair of light sources in a first frequency. A scanning module is used for scanning the light sensor in a second frequency, to obtain states of the light sensor. A controlling module is used for generating data representative of movement of the housing according to the states of the light sensor.

### BACKGROUND

1. Technical Field

The present disclosure relates to computer mice and, particularly, to a mechanical computer mouse.

2. Description of Related Art

A conventional mechanical computer mouse usually includes two encoding disks. A pair of light sources is arranged at one side of one encoding disk, and a pair of light sensors is arranged at an opposite side for receiving light respectively from the light sources. Each encoding disk defines a number of slots that break the beam of light coming from the light sources to produce pulses of light that are picked up by the light sensors. The pulses of light can be used to generate data representation of the movement of the mouse. Although the conventional mechanical mouse can satisfy basic requirements, a new mechanical computer mouse is still needed.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a schematic view of a computer mouse in accordance with one embodiment.

FIG. 2 is a schematic view showing an inner structure of the computer mouse of FIG. 1.

FIG. 3 is a block diagram of the mouse of FIG. 1.

FIG. 4 is a schematic diagram of output signals of a light sensor corresponding to a first pair of light sources when an encoding wheel rotates clockwise.

FIG. 5 is similar to FIG. 4, but showing a diagram of output signals of a light sensor corresponding to the first pair of light sources when the encoding wheel rotates counterclockwise.

FIG. 6 is a table contrasting output signals of a light sensor corresponding to the pair of light sources when the encoding wheel rotates clockwise and counterclockwise.

### DETAILED DESCRIPTION

Embodiments of the present disclosure will now be described in detail below, with reference to the accompanying drawings.

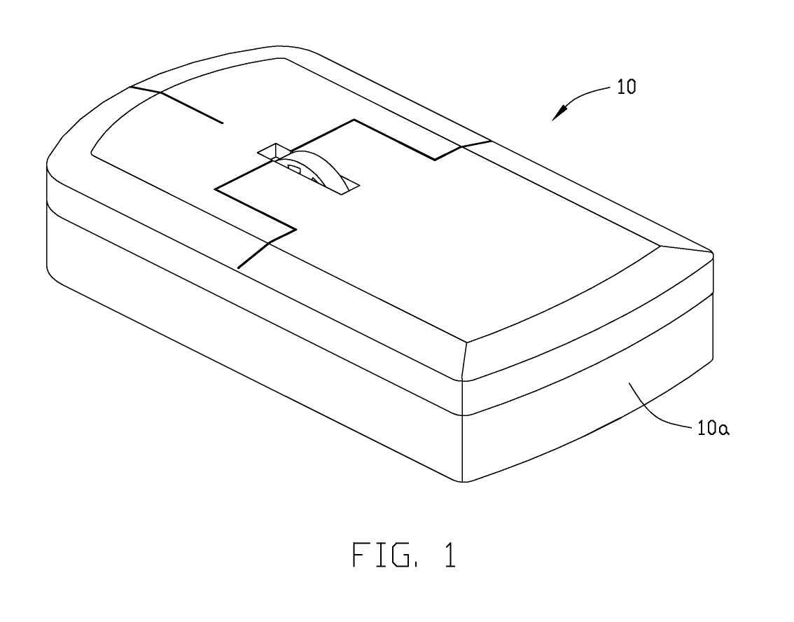

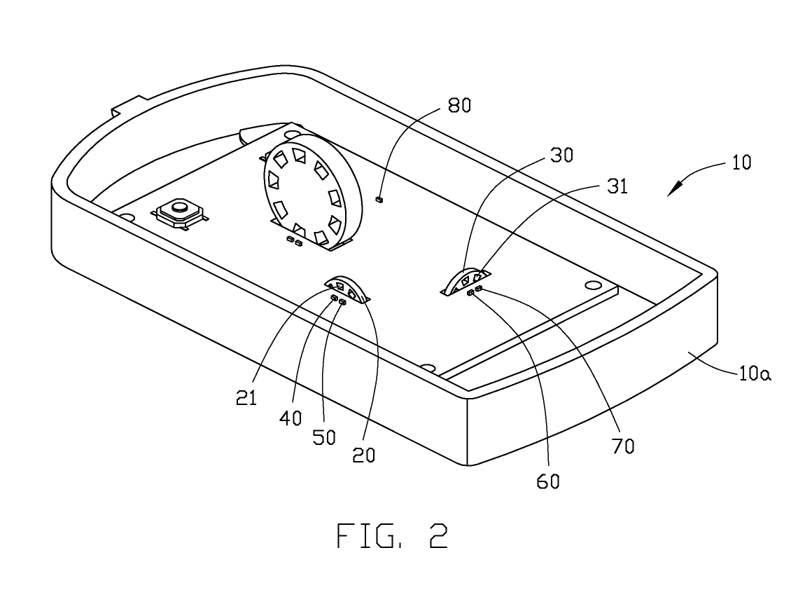

Referring to FIGS. 1 and 2, a mouse 10 includes a housing 10a, a first wheel 20, and a second wheel 30. The wheels 20 and 30 are rotatably connected to the housing 10a. A portion of each of the wheels 20 and 30 is external to the housing 10a. When the housing 10a is held by a user to move relative to a support surface (not shown), such as a desktop, the wheel 20 and/or the wheel 30 roll on the support surface. In the embodiment, the wheels 20 and 30 are substantially perpendicular to each other, which is similar to the arrangement of two encoding disks of a conventional mechanical computer mouse. The wheel 20 defines a plurality of slots 21 that are evenly arranged around the rotating axis of the wheel 20. Similarly, the wheel 30 defines a plurality of slots 31.

The mouse 10 also includes a first pair of light sources 40 and 50, a second pair of light sources 60 and 70, and a light sensor 80. The light sources 40 and 50 can be infrared light emitting diodes (LEDs) and are arranged at one side of the wheel 20. The light sources 60 and 70 are arranged at one side of the wheel 30. The light sensor 80 is configured for receiving light from the light sources 40, 50, 60, and 70 that passes through the slots 31 and/or 21. After receiving the light from any one of the light sources 40, 50, 60, and 70, the light sensor 80 changes from a first state to a second state and returns to the first state when the light is blocked. In the embodiment, the light sensor 80 outputs a high-potential signal (signal “1”) when receiving the light, and outputs a low-potential signal (signal “0”) when the light is blocked.

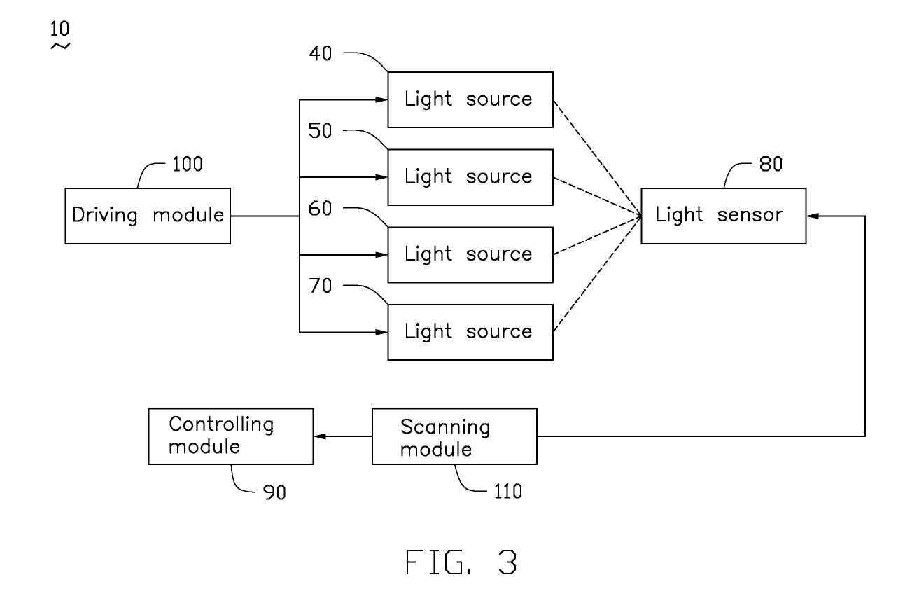

Referring to FIG. 3, the mouse 10 also includes a control module 90, a driving module 100, and a scanning module 110. After the mouse 10 is powered on, the driving module 100 turns on the light sources 40, 50, 60, and 70 successively in a first frequency. The scanning module 100 starts to scan the light sensor 80 in a second frequency after the mouse 10 is powered on, to identify the signal states (signals “0” and “1”) of the light sensor 80. The second frequency is about two times the first frequency, ensuring that no states of the light sensor 80 representation of ON/OFF states of the light sources 40, 50, 60, and 70 will be neglected. In the embodiment, because of the sequence that turns on the light sources 40, 50, 60, and 70, the ON/OFF states of the light source 40 are represented by the signals of number 4n+1 wherein n=0, 1, 2, and so on. Similarly, the signals of number 4n+2, 4n+3, and 4n+4 respectively represent the ON/OFF states of the light sources 50, 60, and 70. The controlling unit 90 can thus identify which light source the signals obtained by the scanning module 110 represent.

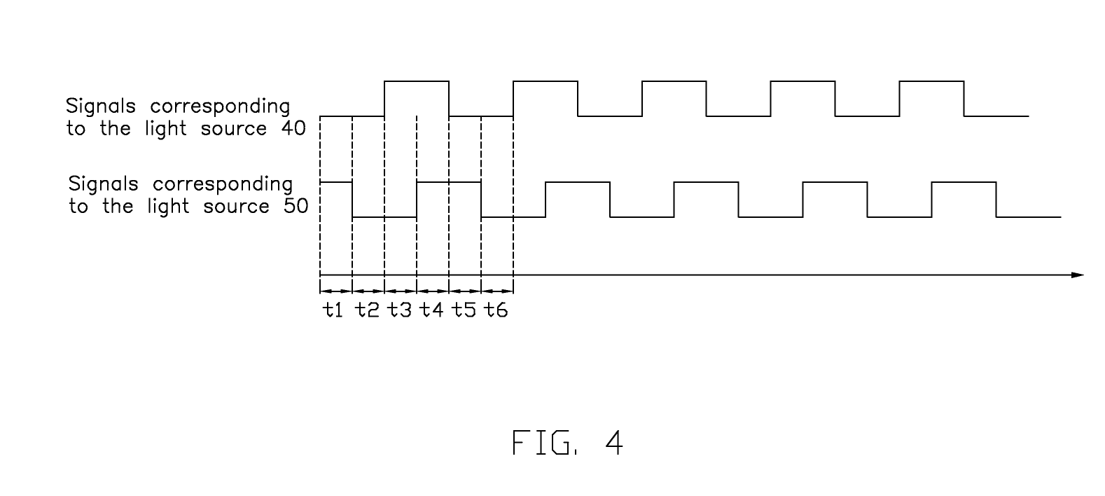

FIG. 4 is a diagram of output signals of the light sensor 80 when the wheel 20 rotates clockwise. The number of the slots 21 is carefully considered, as is the spacing between adjacent slots 21 and the width of the slots 21. The positions of the light sources 40 and 50 and the light sensor 80 are also carefully selected. These carefully selected parameters enable differentiation of the clockwise and counter-clockwise rotation of the wheel 20 by waveform phase analysis of two optically detected signals.

Specifically, when the wheel 20 rotates clockwise and permits the light from the light source 40 to pass through one slot 21 to the light sensor 80, the light sensor 80 then generates a signal “1”. The light source 40 is turned on for a short preset period and then is turned off. While the light source 40 is turned off, the light source 50 is turned off and the light from the light source 50 is blocked by the spacing between the slots 21 spacing between the slots 21 blocks the light from the light source 50. The light sensor 80 is unable to detect the light from the light source 50 and then generates a signal “0”. As the wheel 20 continues to rotate, the light source 40 is turned on again and the light from the light source 40 can still pass through the slot 21. The light sensor 80 then outputs a signal “1”. After the small preset period, the light source 50 is turned on, and the light from the light source 50 can also pass through the slot 21 and the light sensor 80 then outputs a signal “0”. It should be clear that the design of the slots 21 generates a phase discrepancy of 90 degrees between the signals corresponding to the light sources 40 and 50. As the wheel 20 continues to rotate, the signals corresponding to the light sources 40 and 50 become “0” and “1”. As the wheel 20 continues to rotate even more, the signals corresponding to the light sources 40 and 50 become “0” and “0”.

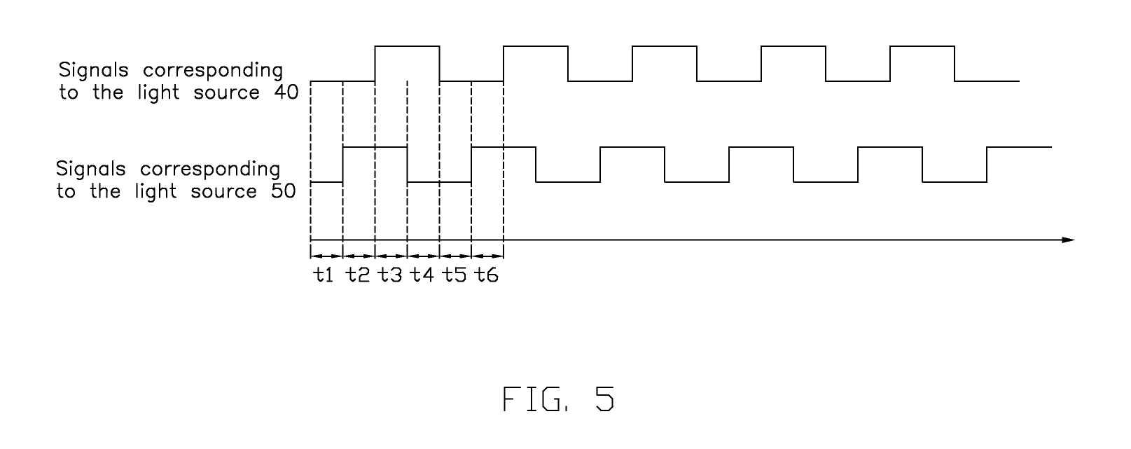

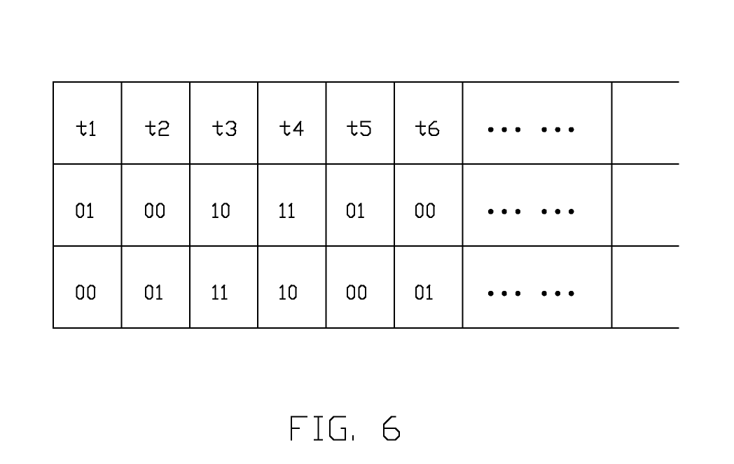

Referring also to FIGS. 5 and 6, when the wheel 20 rotates clockwise, if the output signal of the light sensor 80 corresponding to the light source 40 is “0”, then the output signal of the light sensor 80 corresponding to the light source 50 will be “1” for a period t1. The signals corresponding to light sources 40 and 50 are thus “01”. Therefore, as the wheel 20 continues to rotate, the signals corresponding to light sources 40 and 50 become “00” in period t2, “10” in period t3, and “11” in period t4. As shown, in FIG. 6 that the signals corresponding to light sources 40 and 50 are periodic. To determine whether the wheel 20 is rotating clockwise or counter-clockwise, it needs to determine if the arrangement of the output signals of the light sensor corresponding to light sources 40 and 50 changes from “01”, “00”, “10” to “11” in the proper sequence. For example, when the output signals change from “00” to “10”, it is inferred that the wheel 20 is rotating clockwise.

Similarly, to determine whether the wheel 14 is rotating counterclockwise, it needs to determine if the arrangement of the output signals of the light sensor 80 corresponding to light sources 40 and 50 change from “00”, “01”, “11” to “10” in order.

The controlling unit 90 generates data representation of the moving direction and moving speed of the mouse 10 according to the obtained states (signals “0” and “1”) of the light sensor 80. Specifically, the moving direction is determined based on the rotating direction of the wheel 20 and/or wheel 30. The moving speed is determined based on the changing speed of the signals “01”, “00”, “10” to “11” or “00”, “01”, “11” to “10”. A cursor on a display (not shown) can be controlled to move based on the data, after the data has been sent to a host device (not shown).

In an alternative embodiment, each of the light sources 40, 50, 60, and 70 can be replaced with a light sensor, and the light sensor 80 can be replaced with a light source. Similar to what has been described above, the scanning module 100 scans the four light sensors successively in a predetermined frequency to obtain the signal states (“0” and “1”) of the four light sensors. The controlling module 90 generates data representative of the moving direction and moving speed of the mouse 10 according to the obtained states.

While various embodiments have been described and illustrated, the disclosure is not to be constructed as being limited thereto. Various modifications can be made to the embodiments by those skilled in the art without departing from the true spirit and scope of the disclosure as defined by the appended claims.

What is claimed is:

1. A mechanical mouse comprising:
a housing;
two wheels rotatably connected to the housing and capable of rolling on a supporting surface, the two wheels being substantially perpendicular to each other;
a first pair of light sources and a second pair of light sources arranged at one side of the two wheels, respectively;
a light sensor changing from a first state to a second state after receiving light from any one light source of the first pair of light sources and the second pair of light sources, and changing from the second state to the first state after the one light source is blocked;
a driving module for successively turning on the first pair of light sources and the second pair of light sources in a first frequency;
a scanning module for scanning the light sensor in a second frequency, to obtain states of the light sensor; and
a controlling module for generating data representative of movement of the housing according to the states of the light sensor.

2. The mechanical mouse according to claim 1, wherein the first pair of light sources and the second pair of light sources are infrared light-emitting diode (LED) emitters.

3. The mechanical mouse according to claim 1, wherein the second frequency is two times the first frequency.

4. The mechanical mouse according to claim 1, wherein each of the two wheels defines a plurality of slots to allow light from the first pair of light sources and the second pair of light sources to pass through.

5. The mechanical mouse according to claim 4, wherein the plurality of slots are evenly arranged around a rotating axis of each of the two wheels.

6. A mechanical mouse comprising:
a housing;
two wheels rotatably connected to the housing and capable of rolling on a supporting surface, the two wheels being substantially perpendicular to each other;
a light source;
a first pair of light sensors and a second pair of light sensors arranged at one side of the two wheels, respectively, each of the first pair of light sensors and the second pair of light sensors changing from a first state to a second state after receiving light from the light source, and changing from the second state to the first state after the light source is blocked;
a driving module for turning on the light source in a first frequency;
a scanning module for successively scanning the light sensor in a second frequency, to obtain states of the first pair of light sensors and a second pair of light sensors; and
a controlling module for generating data representative of movement of the housing according to the states of the light sensor.

7. The mechanical mouse according to claim 6, wherein light source is an infrared LED emitter.

8. The mechanical mouse according to claim 6, wherein the second frequency is two times the first frequency.

9. The mechanical mouse according to claim 6, wherein each of the two wheels defines a plurality of slots to allow light from the first pair of light sources and the second pair of light sources to pass through.

10. The mechanical mouse according to claim 4, wherein the plurality of slots are evenly arranged around a rotating axis of each of the two wheels.
